(19) United States
(12) Patent Application Publication
(10) Pub. No.: US 2003/0228563 A1
(43) Pub. Date: Dec. 11, 2003

(54) System and method for creating and evaluating learning exercises

(76) Inventors: Henry W. Sang JR., Cupertino, CA (US); Chuck Untulis, Sunnyvale, CA (US); Chit Wei Saw, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/166,411

(22) Filed: Jun. 11, 2002

(51) Int. Cl. G09B 7/00

(52) U.S. Cl. 434/323

(57) ABSTRACT

A system and method for helping teachers create and evaluate learning exercises is disclosed. The system comprises a creator interface module, wherein the creator interface module comprises a database comprising a plurality of questions, wherein one or more of the plurality of questions are formatted to create a learning exercise distributed to one or more students. The system also comprises a grader interface module, wherein the grader interface module assists the teacher in evaluating one or more sets of answers to the questions in the learning exercise received from the students, wherein each set of answers corresponds to one student, and wherein the grader interface module produces one or more sets of data corresponding to the sets of answers. A memory module records the sets of data.

### TECHNICAL FIELD

The technical field is educational systems and methods, particularly systems and methods for creating and evaluating learning exercises.

### BACKGROUND

Current teaching methods generally consist of manual systems for creating and evaluating learning exercises that exist between teachers and students, such as homework assignments and examinations. Teachers typically create and evaluate the learning exercises using a manual, “brute-force” approach, which tends to be both inefficient and ineffective.

The current teaching systems are problematic in several ways. First, the current systems are labor intensive and time consuming. Teachers typically must spend a lot of time to create and evaluate homework assignments and examinations for their students. The inordinate amount of time that is usually required to properly evaluate assignments and examinations results in delayed feedback from the teacher to the students, parents and administrators regarding the performance of the students. Unfortunately, due to the delay in the teacher's feedback, the material to be learned by the students is no longer fresh in the students' minds and, therefore, it is difficult for the students to learn from their past performance. Second, the current systems are susceptible to inconsistent evaluation. This problem may arise from human error in judgment and the finite ability of a teacher to focus on a particular task when that task is performed with substantial repetition. For example, it may be difficult for a teacher to maintain focus in grading a particular question on a homework assignment for every student in a class if there is a high student-to-teacher ratio in the class. This difficulty is further exacerbated by having to make repetitive comments for the same question for all of the students. Third, the current systems are vulnerable to potential biases and prejudices of the teacher. The resulting unfairness in the evaluation process may negatively impact the educational development of students in the class. Fourth, the current systems are not well suited to tracking the strengths and weaknesses of individual students over a period of time, such as an entire school year. Finally, the current systems do not allow for consistent evaluation when people other than the teacher assist in the evaluation process.

### SUMMARY

A system for helping teachers create and evaluate learning exercises is disclosed. The system comprises a creator interface module, wherein the creator interface module comprises a database comprising a plurality of questions, wherein one or more of the plurality of questions are formatted to create a learning exercise distributed to one or more students. The system also comprises a grader interface module, wherein the grader interface module assists the teacher in evaluating one or more sets of answers to the questions in the learning exercise received from the students, wherein each set of answers corresponds to one student, and wherein the grader interface module produces one or more sets of data corresponding to the sets of answers. The system also comprises a memory module, wherein the memory module records the sets of data.

Also disclosed is a method for helping teachers create and evaluate learning exercises. The method comprises the steps of selecting one or more questions from a creator interface module, wherein the creator interface module comprises a database comprising a plurality of questions; formatting the questions to create a learning exercise; distributing the learning exercise to one or more students; evaluating by a grader interface module one or more sets of answers to questions in the learning exercise received from the students, wherein each set of answers corresponds to one student; producing by the grader interface module one or more sets of data corresponding to the sets of answers; and recording the sets of data.

A computer-readable medium containing instructions for creating and evaluating learning exercises is also disclosed. The instructions comprise the steps of selecting one or more questions from a creator interface module, wherein the creator interface module comprises a database comprising a plurality of questions; formatting the questions to create a learning exercise; distributing the learning exercise to one or more students; evaluating by a grader interface module one or more sets of answers to questions in the learning exercise received from the students, wherein each set of answers corresponds to one student; producing by the grader interface module one or more sets of data corresponding to the sets of answers; and recording the sets of data.

A computer-readable medium embodying a program of instructions is also disclosed. The program of instructions comprises selecting one or more questions from a creator interface module, wherein the creator interface module comprises a database comprising a plurality of questions; formatting the questions to create a learning exercise; distributing the learning exercise to one or more students; evaluating by a grader interface module one or more sets of answers to questions in the learning exercise received from the students, wherein each set of answers corresponds to one student; producing by the grader interface module one or more sets of data corresponding to the sets of answers; and recording the sets of data.

Other aspects and advantages will become apparent from the following detailed description, taken in conjunction with the accompanying figures.

### DESCRIPTION OF THE DRAWINGS

The detailed description will refer to the following drawings, wherein like numerals refer to like elements, and wherein:

FIG. 1 is a block diagram illustrating a system for helping teachers create and evaluate learning exercises according to one embodiment; and

FIG. 2 is flow diagram illustrating a method for helping teachers create and evaluate learning exercises according to one embodiment.

### DETAILED DESCRIPTION

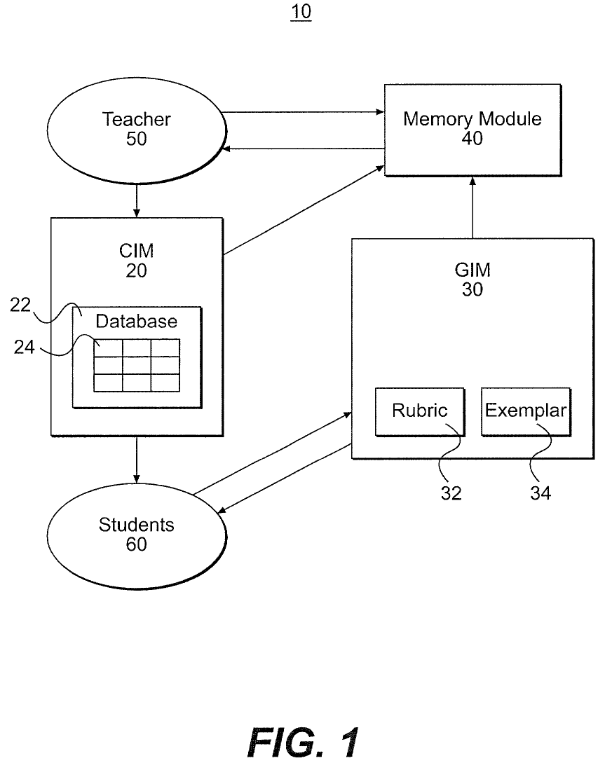

FIG. 1 is a block diagram illustrating a system 10 for helping teachers create and evaluate learning exercises for students. Learning exercises may be, for example, homework or class assignments, exams and quizzes. Teachers may be educators of all kinds, including, for example, professional and substitute teachers, tutors and instructors. The system 10 includes a creator interface module (CIM) 20, a grader interface module (GIM) 30 and a memory module 40. The CIM 20 and GIM 30 are software modules, which may be compatible with various well-known operating systems and software packages. The memory module 40 may be, for example, a hard disk drive. A teacher 50 uses the CIM 20 to create a learning exercise and distributes the learning exercise to students 60. Once the students 60 have completed the learning exercise, the students' answers are received and evaluated by the GIM 30. The teacher 50 uses the GIM 30 to process the answers and produce data corresponding to the processed answers. The memory module 40 records the data. The teacher 50 may use the GIM 30 to distribute the processed answers back to the students for their immediate feedback. The teacher 50 may also view and analyze the recorded data in the memory module 40 to keep track of student performance and to adjust curriculum and teaching as needed. Additionally, the recorded data may be sent to the parents of the students and appropriate school administrators to provide feedback regarding student performance.

The CIM 20 allows the teacher 50 to create learning exercises from a master set of questions. The CIM 20 comprises a database 22 that stores various questions as objects 24 in the database 22. The term “object” refers to any item that can be individually selected and manipulated, including, for example, shapes and pictures that appear on a display screen. Objects may be self-contained entities that comprise both data and programmed procedures that allow manipulation and presentation of the data. Each object 24 may have various attributes related to the nature of the question. Attributes may include, for example, question type (e.g., multiple choice, true-false, one-word fill-in, pictures, drawings, etc.), level of difficulty, associated rubrics or exemplars and mandated standard requirements regarding performance. The term “rubric” refers to a method of giving a score to a learning exercise, such as a homework assignment or exam, that comprises a set of criteria that describes the expectations that are being evaluated and provides descriptions of the levels of quality to be used to evaluate students' work. The term “exemplar” refers to one or more best-of-class answers. The term “standard” refers to a specification of what students should know at specific points in their education.

The CIM 20 enables the teacher 50 to select various objects in the database 22 depending on the attributes desired and to format a page of objects to create a learning exercise. The term “page” refers to a fixed amount of data. For example, a page may be defined as a page in a book, a page on a display screen or a web page. A page may be presented in various forms of media, including paper and electronic means. Learning exercises may be stored in memory module 40 for future use. The learning exercise is distributed to one or more students 60 in paper form or electronic means, including, for example, by electronic mail.

The GIM 30 receives one or more sets of answers to the questions in the learning exercise from the students 60 and enables the teacher 50 to be more effective and efficient in evaluating the learning exercise. Each set of answers corresponds to one student. The students 60 may submit their answers using the means in which they received the learning exercise. If the learning exercise is distributed and subsequently submitted in paper form, each piece of paper may be scanned into the GIM 30 as, for example, a tiff image. Each tiff image may then be broken down into answer objects, wherein each answer object may be assigned a unique identification number and an identification number of the corresponding student. An optical character recognition algorithm may be used to extract printed elements from answer objects.

The GIM 30 enables the teacher 50 to use a rubric interface 32 or an exemplar interface 34 in evaluating the learning exercise. A rubric is especially useful when there is no absolute definition of a right or wrong answer. An example of a rubric interface 32 is described as follows. The rubric interface 32 may display a list of words and phrases in the correct order that should be included in a student's answer. The teacher 50 may enter the appropriate rubric ahead of time. If all of the words and phrases are present in the answer, a high score will be assigned to the answer. A lower score will result if only a few of the required words and phrases are present in the answer. An exemplar interface 34 may also be used when the teacher 50 encounters a student's answer that is a perfect or near perfect answer to the question. The teacher 50 may copy the student's answer into the exemplar interface 34 and use the exemplar as a standard in evaluating other students' answers.

If the specific question corresponds to an answer that may be clearly judged as right or wrong, such as a one-word answer or numeric answer, the GIM 30 may enable the teacher 50 to automate the evaluation of the answers. The GIM 30 compares the students' answers to a correct answer entered by the teacher 50 and automatically assigns a score to the answer (i.e., full credit or no credit). Additionally, the use of the rubric interface 32 or the exemplar interface 34 in the GIM 30 allows the teacher 50 to enlist third party graders to assist in the evaluation process. Third party graders may include, for example, other teachers, other students and parents of the students. The rubric interface 32 or the exemplar interface 34 allows third party graders to assist in the evaluation of learning exercises without requiring the level of knowledge possessed by the teacher 50 in the specific subject area to be taught. Further, in order to assist the teacher 50 in evaluating learning exercises, completed learning exercises may be sent to other teachers in remote locations who may use the GIM 30 in evaluating the learning exercises. The other teachers may be paid on a contract basis for their services.

The GIM 30 provides various features in evaluating answers in a learning exercise. A first feature enables evaluation of answers to one or more questions at a time for a subset or all of the students 60. The GIM 30 displays the answers of the students 60 to one or more specific questions at a time and provides each student's name and answer to each specific question. The teacher 50 may focus on evaluating just one question at a time for all of the students 60, which may result in more effective and efficient evaluation. Alternately, the teacher 50 may evaluate answers to more than one question at a time for all of the students 60, which may be useful and efficient if several questions relate to the same subject area or are of the same question type. Additionally, the teacher 50 may evaluate answers to one or more questions at a time for a defined subset of the students 60, which may be useful in identifying the effectiveness of teaching models in regards to the subset of students 60 or to track the performance of the subset of students 60 relative to the entire class. The teacher 50 may define the subset of the students 60 based on various criteria.

A second feature provides anonymity to the students 60 in the evaluation process. The GIM 30 assigns a random identification number to each student, which is attached to each answer submitted by the student. The identity of a student is not made known until after the evaluation is completed, at which time the random identification numbers are matched to the appropriate students 60 before results are returned to the students 60. Providing anonymity to the students 60 in the evaluation process provides a safeguard against potential biases and prejudices of the teacher 50. Additionally, student anonymity allows the teacher 50 to enlist the assistance of the parents of the students or other students in assisting in the evaluation process while ensuring fairness and objectivity.

A third feature enables the teacher 50 to attach helpful information to a student's answer during the evaluation process so that the student may receive additional feedback. For example, the teacher 50 may provide comments explaining why the student's answer was incorrect or provide a note of encouragement or praise. Additionally, for example, the teacher 50 may provide information from a rubric or exemplar used by the teacher 50 in the evaluation process to show the student a superior answer. Further, for example, the teacher 50 may provide annotations for finding useful information related to the question being evaluated, such as URLs for finding additional information on the internet or the citations of relevant texts or periodicals. Any information to be attached to a student's answer is entered by the teacher 50 into the GIM 30, which annotates the student's answer with the entered text.

The GIM 30 processes the answers as described above. Questions and evaluated answers, along with any additional information attached to the evaluated answers, are reassembled for each student and distributed back to each student for feedback. The GIM 30 produces one or more sets of data corresponding to the sets of evaluated answers, wherein each set of data corresponds to one student, and the data is recorded by memory module 40. The recorded data may be imported into various well-known data analysis software packages for statistical analysis of individual student's performance and the performance of the entire class. The data may be formatted and sent to the parents of the students and appropriate school administrators to provide feedback regarding student performance. The teacher 50 may use the data to determine which students are experiencing problems understanding certain concepts. Additionally, the teacher 50 may use the data to track the performance of one or more students over a definite period of time. Further, the teacher 50 may use the data to recognize patterns in class performance that may indicate the need for adjustments in teaching models used in class. Data may be tracked over specific time frames, such as, for example, on a monthly, quarterly or yearly basis, which greatly expedites end of period grading.

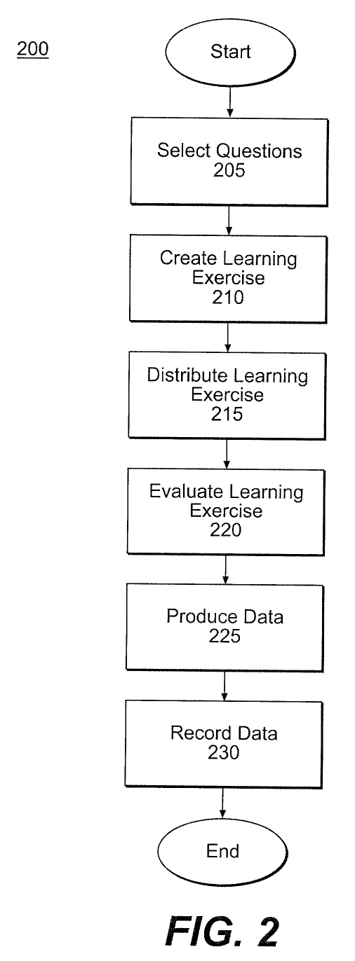

FIG. 2 is flow diagram 200 illustrating a method for helping teachers create and evaluate learning exercises. In step 205, the teacher 50 selects one or more questions from the database 22 of the CIM 20. In step 210, the teacher 50 uses the CIM 20 to format the questions to create a learning exercise. The learning exercise is distributed to one or more students 60 in step 215. In step 220, the teacher 50 uses the GIM 30 to evaluate one or more sets of answers to questions in the learning exercise received from the students 60, wherein each set of answers corresponds to one student. The GIM 30 processes the answers and produces one or more sets of data corresponding to the sets of answers in step 225. In step 230, the memory module 40 records the sets of data.

The method illustrated by the flow diagram 200 of FIG. 2 may also be embodied in a computer-readable medium containing instructions for creating and evaluating learning exercises and a computer-readable medium embodying a program of instructions.

While the present invention has been described in connection with an exemplary embodiment, it will be understood that many modifications will be readily apparent to those skilled in the art, and this application is intended to cover any variations thereof.

What is claimed is:

1. A system for helping teachers create and evaluate learning exercises, comprising:
a creator interface module, wherein the creator interface module comprises a database comprising a plurality of questions, wherein one or more of the plurality of questions are formatted to create a learning exercise distributed to one or more students;
a grader interface module, wherein the grader interface module assists the teacher in evaluating one or more sets of answers to the questions in the learning exercise received from the students, wherein each set of answers corresponds to one student, and wherein the grader interface module produces one or more sets of data corresponding to the sets of answers; and
a memory module, wherein the memory module records the sets of data.

2. The system of claim 1, wherein the database of the creator interface module stores the plurality of questions as objects, wherein the objects may be selected based on attributes and formatted on a page.

3. The system of claim 2, wherein the attributes may be one of a question type, level of difficulty, associated rubrics or exemplars and mandated standard requirements regarding performance.

4. The system of claim 1, wherein the learning exercise may be distributed in one of a tangible and electronic form.

5. The system of claim 1, wherein the grader interface module comprises one of a rubric interface and an exemplar interface for evaluating the learning exercise.

6. The system of claim 1, wherein the grader interface module displays the answers of the students to one or more questions at a time and provides each student's name and answer to each question.

7. The system of claim 6, wherein the grader interface module displays the answers of a defined subset of the students, wherein the teacher defines the subset of the students.

8. The system of claim 1, wherein the grader interface module assigns a random identification number to each student and attaches the identification number to each answer submitted by the student.

9. The system of claim 1, wherein the grader interface module annotates the answers with text entered by the teacher.

10. A method for helping teachers create and evaluate learning exercises, comprising the steps of:
(a) selecting one or more questions from a creator interface module, wherein the creator interface module comprises a database comprising a plurality of questions;
(b) formatting the questions to create a learning exercise;
(c) distributing the learning exercise to one or more students;
(d) evaluating by a grader interface module one or more sets of answers to questions in the learning exercise received from the students, wherein each set of answers corresponds to one student;
(e) producing by the grader interface module one or more sets of data corresponding to the sets of answers; and
(f) recording the sets of data.

11. The method of claim 10, wherein the selecting step comprises selecting objects based on attributes, wherein the creator interface module stores the plurality of questions as objects.

12. The method of claim 11, wherein the attributes may be one of a question type, level of difficulty, associated rubrics or exemplars and mandated standard requirements regarding performance.

13. The method of claim 1 1, wherein the formatting step comprises formatting the selected objects on a page.

14. The method of claim 10, wherein the distributing step comprises distributing the learning exercise in one of a tangible and electronic form.

15. The method of claim 10, wherein the evaluating step comprises evaluating the answers using one of a rubric interface and an exemplar interface.

16. The method of claim 10, wherein the evaluating step further comprises the steps of:
displaying the answers of the students to one or more questions at a time; and
providing each student's name and answer to each question.

17. The method of claim 16, wherein the displaying step further comprises displaying the answers of a defined subset of the students, wherein the teacher defines the subset of the students.

18. The method of claim 10, wherein the evaluating step further comprises the steps of: assigning a random identification number to each student; and
attaching the identification number to each answer submitted by the student.

19. The method of claim 10, wherein the evaluating step further comprises the step of annotating the answers with text entered by the teacher.

20. A computer-readable medium containing instructions for creating and evaluating learning exercises, the instructions comprising the steps of:
(a) selecting one or more questions from a creator interface module, wherein the creator interface module comprises a database comprising a plurality of questions;
(b) formatting the questions to create a learning exercise;
(c) distributing the learning exercise to one or more students;
(d) evaluating by a grader interface module one or more sets of answers to questions in the learning exercise received from the students, wherein each set of answers corresponds to one student;
(e) producing by the grader interface module one or more sets of data corresponding to the sets of answers; and
(f) recording the sets of data.

21. The computer-readable medium of claim 20, wherein the selecting step comprises selecting objects based on attributes, wherein the creator interface module stores the plurality of questions as objects.

22. The computer-readable medium of claim 21, wherein the attributes may be one of a question type, level of difficulty, associated rubrics or exemplars and mandated standard requirements regarding performance.

23. The computer-readable medium of claim 21, wherein the formatting step comprises formatting the selected objects on a page.

24. The computer-readable medium of claim 20, wherein the distributing step comprises distributing the learning exercise in one of a tangible and electronic form.

25. The computer-readable medium of claim 20, wherein the evaluating step comprises evaluating the answers using one of a rubric interface and an exemplar interface.

26. The computer-readable medium of claim 20, wherein the evaluating step further comprises the steps of:
displaying the answers of the students to one or more questions at a time; and
providing each student's name and answer to each question.

27. The computer-readable medium of claim 26, wherein the displaying step further comprises displaying the answers of a defined subset of the students, wherein the teacher defines the subset of the students.

28. The computer-readable medium of claim 20, wherein the evaluating step further comprises the steps of:
assigning a random identification number to each student; and
attaching the identification number to each answer submitted by the student.

29. The computer-readable medium of claim 20, wherein the evaluating step further comprises the step of annotating the answers with text entered by the teacher.

30. A computer-readable medium embodying a program of instructions, said program of instructions comprising:
(a) selecting one or more questions from a creator interface module, wherein the creator interface module comprises a database comprising a plurality of questions;
(b) formatting the questions to create a learning exercise;
(c) distributing the learning exercise to one or more students;
(d) evaluating by a grader interface module one or more sets of answers to questions in the learning exercise received from the students, wherein each set of answers corresponds to one student;
(e) producing by the grader interface module one or more sets of data corresponding to the sets of answers; and
(f) recording the sets of data.

31. The computer-readable medium of claim 30, wherein the selecting step comprises selecting objects based on attributes, wherein the creator interface module stores the plurality of questions as objects.

32. The computer-readable medium of claim 31, wherein the attributes may be one of a question type, level of difficulty, associated rubrics or exemplars and mandated standard requirements regarding performance.

33. The computer-readable medium of claim 31, wherein the formatting step comprises formatting the selected objects on a page.

34. The computer-readable medium of claim 30, wherein the distributing step comprises distributing the learning exercise in one of a tangible and electronic form.

35. The computer-readable medium of claim 30, wherein the evaluating step comprises evaluating the answers using one of a rubric interface and an exemplar interface.

36. The computer-readable medium of claim 30, wherein the evaluating step further comprises the steps of:
displaying the answers of the students to one or more questions at a time; and
providing each student's name and answer to each question.

37. The computer-readable medium of claim 36, wherein the displaying step further comprises displaying the answers of a defined subset of the students, wherein the teacher defines the subset of the students.

38. The computer-readable medium of claim 30, wherein the evaluating step further comprises the steps of:
assigning a random identification number to each student; and
attaching the identification number to each answer submitted by the student.

39. The computer-readable medium of claim 30, wherein the evaluating step further comprises the step of annotating the answers with text entered by the teacher.
